(19) United States
(12) Patent Application Publication
(10) Pub. No.: US 2002/0111984 A1
(43) Pub. Date: Aug. 15, 2002

(54) Server system for automatic multiple action document processing

(76) Inventors: Robert Michael Getler, Lexington, KY (US); Christopher Raymond Nash, Lexington, KY (US); Craig Anthony Rudolph, Lexington, KY (US); Suzanne Marie Thompson, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 09/783,368

(22) Filed: Feb. 14, 2001

(51) Int. Cl. G06F 9/00

(52) U.S. Cl. 709/105

(57) ABSTRACT

A server system for a document processing system includes a plurality of input sources. A plurality of satellite servers are connected to the input sources. The satellite servers receive a plurality of digital files from the input sources. A central server is connected to the satellite servers. The central server receives the digital files from the satellite servers and performs at least one action on at least one of the digital files.

### BACKGROUND OF THE INVENTION

1. Field of the Invention

The present invention relates to processing documents, and, more particularly, to a server system for processing documents.

2. Description of the Related Art

Business organizations have many forms and documents that need to be stored and processed electronically in order to get the documents' information into the business process. Often these paper documents must be scanned and then later processed manually. If multiple operations need to be performed on one document, the document must often be handled multiple times. Documents may come from multiple sources, requiring duplicate ways to get a document into the business process.

What is needed in the art is a method and apparatus for acquiring an image, performing multiple operations on the image, and introducing the image into the workflow process of a business.

### SUMMARY OF THE INVENTION

The present invention provides a server that can perform multiple operations on a single document. The server can take input from a variety of sources such as scanners, remote client personal computers, and other hardware devices. The document is submitted once and one simple job is selected, which may cause the server to perform multiple actions.

The invention comprises, in one form thereof, a server system for a document processing system. The server system includes a plurality of input sources. A plurality of satellite servers are connected to the input sources. The satellite servers receive a plurality of digital files from the input sources. A central server is connected to the satellite servers. The central server receives the digital files from the satellite servers and performs at least one action on at least one of the digital files.

An advantage of the present invention is that a server can process a document by performing multiple operations on a single document.

Another advantage is that, if multiple operations need to be performed on one document, the document does not need to be handled multiple times.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram of one embodiment of a server system of the present invention; and

FIG. 2 is a flow chart illustrating the processing of a job by the server system of FIG. 1.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

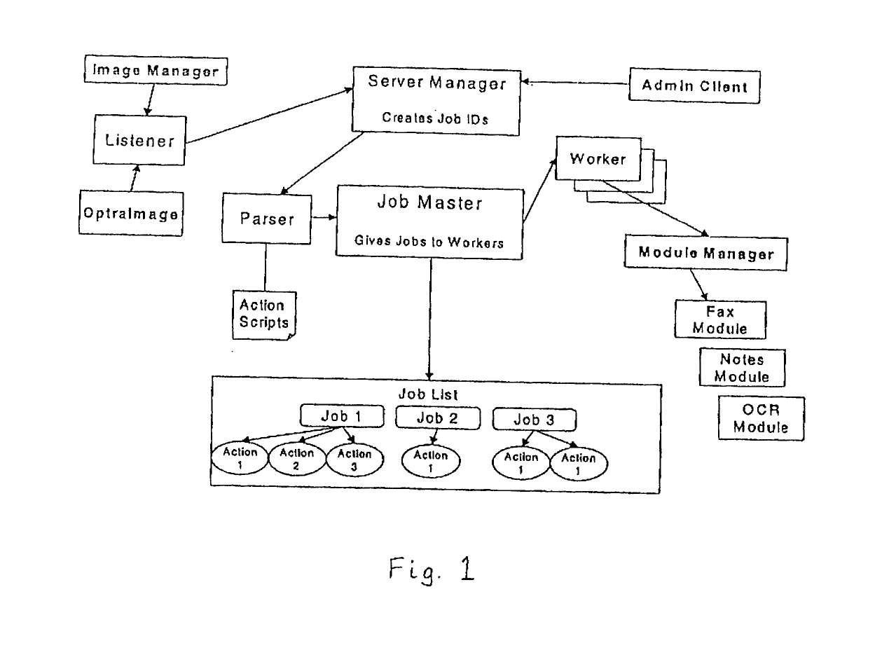

Referring now to the drawings, and, more particularly, to FIG. 1, there is shown one embodiment of a server system of the present invention. The system includes devices for inputting digital files such as electronic images and documents, and a server to receive the digital files and process them. The input devices shown in FIG. 1 include an OptraImage device and Image Manager client software running on a personal computer (not shown). An OptraImage device is an input device including an operator panel and an attached scanner. Image Manager is a software application, produced by Lexmark International, Inc., that can view and manipulate images. Other input sources can also be used, such as another server or another type of hardware device.

Image Manager and OptraImage are the two sources of documents for the server. The Listener runs on the server machine and waits for input sources to send a job.

A job consists of an identifier or label for the job, information about the job such as timestamp and file format, and the actual image data for the document. A label is a name that identifies a job to the server. If available from the input source, an index for the image may be part of the job data as well. This index can later be used to identify the transmitted document.

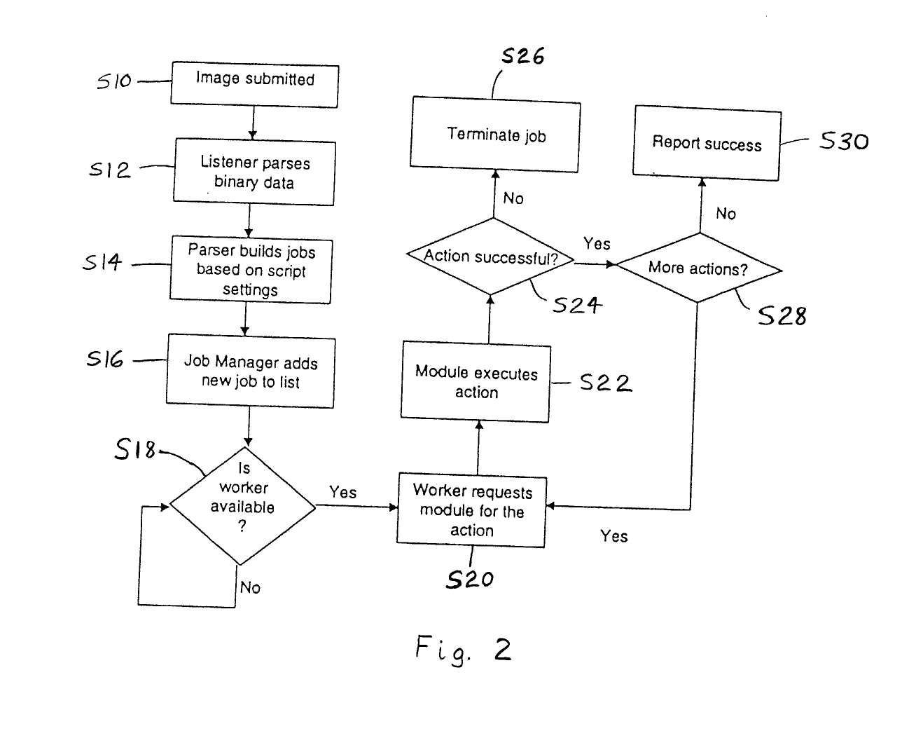

After a digital file is submitted (Step S10; FIG. 2), the Listener parser binary data and passes the job to the Parser (Step S12). The Parser examines the job label. Each job label corresponds to a script. The script lists and describes the actions or steps that compose the job and the settings needed for those steps. A job may include one or more actions such as email the document, convert the document to another format, print the document, etc. The Parser builds a job object including one or more action objects (Step S14). Each action may require a set of parameters. The Parser builds these parameters based on details of the script. Such parameters may include target filename, file format, printer port, recipient name, etc. The output from one action may be the input for a subsequent action.

The script files exist on the server and can be used from multiple OptraImage devices or Image Manager clients. Because each script can include one or more actions, many operations can be performed on a document that was scanned only once. Additionally, scripts may specify actions to perform on a group of documents rather than just a single document.

Once created, the Job Master adds the job object to its list of jobs (Step S16). There may be multiple lists of jobs. There is one list for interactive actions requiring rapid response. These are actions from a user interactive client such as Image Manager. There is a list for non-interactive jobs requiring less immediate response. These are jobs received from OptraImage devices or operations expected to take a long time such as character recognition of a large document. Additionally, there is a third list for use in a multiple server environment and for internal server jobs such as cleaning up internal lists, etc. A pool of worker threads exists for servicing jobs.

After it is determined that a worker thread has become available (Step S18), the worker is assigned a job. Multiple jobs are serviced simultaneously. Worker threads examine individual actions of the job and request a module from the Module Manager (Step S20).

Action Modules are independent software components that perform one type of related tasks such as email, print and faxing. Each module can perform more than one action. For example, a print module may print documents through a printer driver as well as print documents directly to the printer itself. The individual action modules publish a list of the actions they can perform. When a worker thread requests a module object, the Module Manager searches the list of published actions to determine what module can handle the requested action and creates a module to perform the action (Step S22). A determination is made as to whether the action was successful (Step S24). If the action was not successful, the job is terminated (Step S26). If the action was successful, it is determined if any additional action is required (Step S28). If another action is needed, the worker again requests a module to perform the action (Step S20). If another action is not needed, the success of the action is reported (Step S30). Once all actions are completed, the job is removed from the list.

The server maintains its state continuously via a rollback file. When a job changes state, this data is written to the rollback file. In the event of a controlled shutdown of the server, the server can easily resume all jobs in process when the server is restarted. In the event of a hardware or software failure, the state of the server will still be fundamentally intact when the server is restarted.

There is also an Administrator Client for configuring and monitoring the server. The primary purpose of the Administrator Client is to provide settings for the server and its action modules such as location of mail servers, etc. The Administrator Client also provides an interface for creating the scripts that control jobs and provides an interface to place the job labels on the OptraImage devices. Additionally, the Administrator Client monitors jobs running on the server and displays history of previously completed jobs.

A server may be used as an input source for another server. The input source servers are satellite servers. There are several possible benefits of this configuration. A single server may become overwhelmed with multiple OptraImage or Image Manager input sources. Multiple servers can serve the numerous input sources and then send these jobs on to a central server for actual processing as time permits.

Some action modules may introduce additional cost to the system due to the software required for the action. Having one centralized server receiving input from multiple satellite servers allows the costly software to be installed only once, thus reducing overall cost of the system.

Some businesses have network traffic capacity problems during peak business hours. Using satellite servers to service local OptraImage or Image Manager clients will allow the servers to store accumulated jobs during the peak hours. The accumulated jobs can then be scheduled to be passed along to the central server during off-peak time periods to reduce network traffic during peak time periods.

In addition to electronic images, the server is capable of handling .doc, .xls and any other digital files. For example, if a .doc file is sent, it could be attached to an email and put into a Notes database. The server may not be able to perform all functions of .doc and .xls digital files, however.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A server system for a document processing system, said server system comprising:
a plurality of input sources;
a plurality of satellite servers connected to said input sources, said satellite servers being configured to receive a plurality of digital files from said input sources; and
a central server connected to said satellite servers, said central server being configured to receive said digital files from said satellite servers and perform at least one action on at least one of said digital files.

2. The server system of claim 1, wherein said satellite servers are configured to store accumulated jobs.

3. The server system of claim 2, wherein said satellite servers are configured to pass the accumulated jobs to said central server during at least one off-peak time period.

4. The server system of claim 1, wherein said input sources include at least one of a scanner and a personal computer.

5. The server system of claim 1, wherein at least one said digital file comprises an electronic image.

6. A method of processing a digital file, comprising the steps of:
scanning a document with a scanner to thereby obtain the digital file;
building a job object including a plurality of action objects; and
performing the action objects on the digital file.

7. The method of claim 6, wherein said building step is performed by a parser.

8. The method of claim 6, wherein said building step is dependent upon a plurality of script settings.

9. The method of claim 6, wherein said action objects include at least one of printing, emailing and faxing.

10. The method of claim 6, wherein said performing step includes assigning said action objects to individual worker threads.

11. The method of claim 10, wherein said performing step includes requesting at least one action module.

12. A server system for a document processing system, said server system comprising a server configured to perform a plurality of operations on a single digital file.

13. The server system of claim 12, further comprising at least one input source connected to said server.

14. The server system of claim 13, wherein said at least one input source comprises at least one of a scanner and a personal computer.

15. The server system of claim 12, further comprising an administrative client for at least one of configuring and monitoring said server.
